(19) United States
(12) Patent Application Publication
(10) Pub. No.: US 2019/0362650 A1
(43) Pub. Date: Nov. 28, 2019

(54) Dimensional Laser Sound Blind Aid (DLS Blind Aid)-A Method to Convey 3D Information to the Blind

(71) Applicants: Tang Kechou, Liuzhou (CN); Li Jingyi, Hong Kong (CN)

(72) Inventors: Tang Kechou, Liuzhou (CN); Li Jingyi, Hong Kong (CN)

(21) Appl. No.: 16/446,745

(22) Filed: Jun. 20, 2019

(51) Int. Cl. G09B 21/00

(52) U.S. Cl. CPC G09B 21/007

(57) ABSTRACT

A device that helps the blind to navigate by informing 3D images to them, it uses laser (or other methods like ultrasonic, photogrammetric tech etc.) to obtain a 3D image (collection of distance vectors), and conveys this image to the user by loudspeakers on a helmet or skin vibrators on a tactile board through the ‘Time Gap Method’, Time Gap Method means to use each loudspeaker (or vibrator) to represent one distance vector, direction of the vector represented by position of the loudspeaker (or vibrator), length of the vector is represented by the length of time between obtaining the 3D image (by emitting laser or other method) and the brief ringing of the loudspeaker (or brief vibrating of the vibrator).

### TECHNIQUE FIELD

The invention aims at helping the blind to ‘sense’ their surrounding 3D space.

### BACKGROUND

This application will focus only on this invention and will not involve actual design of the product, however the invention i s key to the direct creation of a whole new series of product, which can be designed and produced by professional companies through available technology.

Up to now all blind product used for navigation could only inform the user with space information of just one direction, or a few directions on a 2D surface, and there is still no effective solution to inform 3D space information to the blind user, but this invention solves the difficulty, and can very effectively ‘tell’ the user a 3D image.

### BRIEF SUMMARY OF INVENTION

Product name: Dimensional Laser Sound Blind Aid (DLS Blind Aid)

It includes the Standard Model and Model With Vibrator Board

### Basic Principle:

Disperse certain number of distance-measuring laser emission jets (receiver included) on a ball or semi-ball (shown in FIG. 1 below) which would later be referred as ‘Laser Ball’, it is like an Integrated Multi-Jet Distance Meter and by emitting laser to the surrounding can gain the 3-Dimension Distance Image of the space (collection of distance vectors), the product then conveys this Image to the user through the small loudspeakers dispersed on a ‘sound helmet’. The loudspeakers and laser emission jets shall be in one-to-one correspondence, which is that the position of a loudspeaker on the helmet shall correspond to the position and direction of the according emission jet on the Laser Ball. Then the loudspeakers will use time gap, pitch, and timbre of sound to express the length of distance. Thus the direction and length of the distance are all expressed and could be conveyed to the user through sound.

Time gap: the time between emitting laser and the ringing of a loudspeaker (a brief ringing), time gap will change linearly to distances.

Such as: distance long—time gap long; distance short—time gap short. Suppose time gap for 1 meter is 0.1 second, then time gap for 2 meter is 0.2 second, for 3 meter is 0.3 second, and so on.

For the pitch it can be: Distance short—pitch high, distance long, pitch low

But the use of Pitch and Timbre can be multi, they can be used along with volume to mark different distance, or to mark different positions of the loudspeakers, or to mark other properties of detected obstacles.

In the Model With Vibrator Board, a tactile board dispersed with vibrators is introduced, which conveys the distance by ‘Time Gap’ of the vibrators to the user via touch. The vibrator board could be replaced by ‘tongue board’ similar as used in Brainport. The vibrator on the board will function just like the loudspeakers on the helmet; as human ear can only distinguish a limited number of sound, thus by applying the vibration board on skin, resolution of the 3D image can be further promoted.

If to obtain a 3D image with higher resolution, laser jets required may be too many, thus can use ways like rotating a row of laser jets, or use a Lidar, or use photogrammetric method to obtain higher resolution of 3D image.

The above could be the ‘Basic Principle’ of the product; the content below will further illustrate it, as the invention is just simple and clear for any professional, the illustration mainly focuses on showing certain potential of this invention.

The design of an actual product is not involved, honestly these are out of the ability of the inventor, but it is obvious that a whole new series of product will be created due to this invention through available technology.

### The Invention as a Solution to Current Technical Difficulty

As mentioned above, any current blind product for navigation could only at one time inform the length of one direction to the blind user, or a few directions on a 2D surface; but the Dimensional Laser Sound Blind Aid can inform the user of many directions in 3D space at just ‘one time’, the key is to use the ‘Time Gap Method’.

Engineers had once used ultrasound and tried to ‘slow down the echo’ to cater for human ear, though not very successful as ultrasound can not get a clear 3D image; also they had tried to use a one-direction laser meter to let the user know the distance of obstacles, also had used method like scanning a 2D distance image with laser then turn distance image into height profile on a fan-shape tactile board. But there is still no way to tell 3D image to the blind

‘Time Gap Method’ can solve these difficulties, the 3D image detected by laser could then be directly linked with ‘slowing down the echo’, thus could enable the user to have a practical bat-like sensitivity.

### Advantageous Effect of Invention

View from now, the invention will profoundly improve the life quality of blind people as it can effectively inform 3D space information to them.

The sound helmet and the vibration board can commonly be used together, and while the vibration board inform the 3D space, the sound helmet can be used for multi functions, for example using specific sound to mark specific shape of obstacle; by using a camera and advanced software, could also tell if the obstacle is a human, vehicle or other objects, could also tell the color of the obstacle. The vibrating instance of each vibrator is brief, but may also consider different pattern of vibration (mild or heavy) to indicate different type of obstacle. These may be very advanced functions, but current technology is fully able to realize them.

Of course it will require substantial training for the user to use this product efficiently, but it is reasonable to conclude that with good training they will achieve great manipulation.

### BRIEF DESCRIPTION OF DRAWINGS

The following drawing can be a rough image of what the target product may look like

FIG. 1. DLS Blind Aid

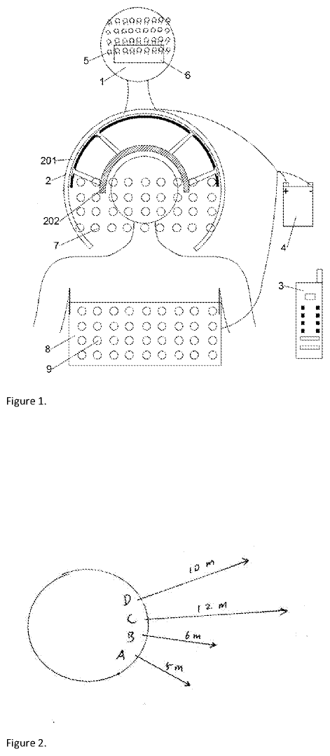

1. Laser ball; 2. Sound Helmet; (201. Outer Cover; 202. Inner Frame); 3. Controller; 4. Battery; 5. Laser Jet (receiver included); 6. Data Processors; 7. Loudspeaker; 8. Vibration Board; 9. Vibrator In order not to shade the face, the loudspeakers could be placed at the back of the head.

### Further Illustration of Basic Principle

As Time Gap Method is key point of the invention, here would give some further illustration.

By emitting multi beams of laser to different directions at the same time, the ‘Laser Ball’ can gain a 3D Distance Image (distance vector collection) of the moment, shown as in FIG. 2:

FIG. 2:

The loudspeaker corresponding to a certain emission jet will use ‘Time Gap’ to express the distance detected by the jet. In FIG. 2, jet-A detects a distance of 5 m, suppose the Time Gap is 0.5 second (0.5 s after laser emitting, the loudspeaker would ring), then for jet-B which detects 6 m, Time Gap will be 0.6 s, here the ‘Time Gap Factor’ (G) would be G=0.1(s\m), and calculated Time Gap can be:

Time Gap: For jet-A: 5 m*G=0.5 s,
For jet-B: 6 m*G=0.6 s
For jet-C: 12 m*G=1.2 s
For jet-D: 10 m*G=1.0 s

G should be adjustable by the user. Commonly when distances are large, G could be small (time gap smaller), when Distances short, G could be larger (time gap larger).

### INDUSTRIAL APPLICABILITY

By the time I am writing this non-provisional application, there are already companies who received this invention telling me that they will release the product.

### Patent Literature

A the inventor, I filed a provisional patent application for this invention on Dec. 4th 2018 at USPTO with Application Number 62/775,052.

After that I published the invention on some platforms and revealed it to some companies, and some them later told me they would release this product, but certainly they had made the research and would use their own technology. I think in this way they hope to use my invention as their ‘own tech’, but it is obvious that my invention is too distinct to be neglected.

Also, I have filed a patent application of same content in my country China.

### Non-Patent Literature

I live in a country where belief in God is not allowed, but I believe in him, thus am often under suppressions of atheists. I see with my eyes the terrible living condition of the blind in China, deprived of any organized help, thus I hope to find an effective solution for them. From the beginning I got quite close to the last solve, I thought of using multi loudspeakers to imitate and slow down the ‘echo’, I also thought of using multi laser jets to detect distance, and inform the user of the distances one by one. But these did not achieve my ideal model and for a long time I failed to break through.

Then one day I went to some fortune tellers to try to introduce the traditional fortune telling method to them. This is called Chinese Ba-Gua, a sophisticated fortune telling system compiled by ‘listening to the words of God’. I wanted to help the fortune tellers to learn a new method as all they commonly knew was nothing more than to examine the ‘hand shape’. But I was sarcastically refused, they said sarcastic words and guffawed at me.

I was quite frustrated, but suddenly, like lightening and thunder, I realized that for my blind aid model, distance could be directly linked with ‘slowing down the echo’. God was angry with the atheists and gave inspiration to me, and so the way to DLS Blind Aid was paved.

1. A blind Product that uses laser (or other method like ultrasonic, photogrammetric tech etc.) to obtain a 3D image (collection of distance vectors), and conveys this 3D image to the user by using loudspeakers on a helmet or skin vibrators on a board through the ‘Time Gap Method’ (illustrated in [0002] and [0008]), the vibrator board can also be replaced by a tongue board using electrodes. Time Gap Method means to use each loudspeaker (or vibrator) to represent one distance vector, direction of the vector represented by position of the loudspeaker (or vibrator), length of the vector is represented by the length of time between obtaining the 3D image (by emitting laser or other method) and the brief ringing of the loudspeaker (or brief vibrating of the vibrator).

2. Other products that utilize the ‘Time Gap Method’ in claim 1 to convey space information to the user.
